(19) United States
(12) Patent Application Publication
(10) Pub. No.: US 2016/0222163 A1
(43) Pub. Date: Aug. 4, 2016

(54) MODIFIED POLYASPARTIC ACIDS, THE PRODUCTION THEREOF AND THEIR USE AS DISPERSANTS AND ENCRUSTATION INHIBITORS IN LAUNDRY DETERGENTS, DISHWASHING DETERGENTS AND CLEANING PRODUCT COMPOSITIONS, AND IN WATER TREATMENTCLEANING PRODUCT COMPOSITIONS, AND IN WATER TREATMENT

(71) Applicant: BASF SE, Ludwigshafen (DE)

(72) Inventors: Jürgen DETERING, Limburgerhof (DE); Gazi TÜRKOGLU, Mannheim (DE); Dietrich FEHRINGER, Dielheim (DE); Heike WEBER, Mannheim (DE); Claudia ESPER, Kindenheim (DE)

(21) Appl. No.: 15/022,007

(22) PCT Filed: Sep. 3, 2014
(86) PCT No.: PCT/EP2014/068674

§ 371 Date: Mar. 15, 2016

(30) Foreign Application Priority Data
Sep. 16, 2013 (EP) 13184578.6

(51) Int. Cl. C08G 69/48; C11D 11/00; C11D 3/37

(52) U.S. Cl. CPC C08G 69/48; C11D 3/3719; C11D 11/0023

(57) ABSTRACT

The present invention relates to processes for preparing modified polyaspartic acids, to modified polyaspartic acids prepared by these processes, and compositions comprising these modified polyaspartic acids. Compositions of this kind are especially cleaning, dishwashing and detergent compositions.

The present invention relates to processes for preparing modified polyaspartic acids, to modified polyaspartic acids preparable by these processes, and compositions comprising these modified polyaspartic acids. Compositions of this kind are especially cleaning, dishwashing and detergent compositions.

Polymers obtainable by free-radical polymerization of carboxyl group-containing monomers have for many years been an important constituent of phosphate-containing and phosphate-free machine detergent compositions, including dishwashing compositions. By means of their soil-dispersing and scale-inhibiting effect, they provide a considerable contribution to the cleaning and rinsing performance of machine dishwashing compositions. For instance, they ensure that no salt deposits of the hardness-forming calcium and magnesium ions remain on the washed dishes. Homopolymers and copolymers of acrylic acid are frequently used for this purpose.

Such polymers are also used in liquid and solid detergents. During the washing process, they actively support the washing performance of the surfactants and prevent graying of the wash due to their soil-dispersing properties. In addition, they act as encrustation inhibitors, i.e. they inhibit the undesired deposition of insoluble inorganic salts (e.g. insoluble carbonates and silicates) on the textile fabric.

Furthermore, such polymers are also used in water-conducting systems as compositions for preventing mineral deposits, such as calcium sulfate and magnesium sulfate, magnesium hydroxide, calcium sulfate and barium sulfate and calcium phosphate, on heat transfer surfaces or in pipelines. Water-conducting systems here include, inter alia, cooling and boiler feed water systems and industrial process water. These polymers are also used as scale inhibitors in seawater desalination by distillation and by membrane processes such as reverse osmosis or electrodialysis.

A disadvantage of these polymers obtainable by free-radical polymerization of carboxyl group-containing monomers is that they are not biodegradable under aerobic conditions, as exist in a communal water treatment plant for example.

Due to increasing environmental awareness, the demand for biodegradable polymeric alternatives to polycarboxylates based on acrylic acid is growing. Biodegradable polymers available on the market to date, such as polyaspartic acid or carboxymethylated inulin, have proven to be commercially viable only with difficulty. The reasons are manifold: inadequate efficacy in the specific application, excessive costs due to complex production methods and/or expensive starting materials or low flexibility, if any, in the polymer synthesis. For instance, the processes being practiced for preparation of polyaspartic acid, in contrast to the processes for preparing polyacrylic acids, do not allow any great variations with respect to structure, molecular weight and degree of neutralization. The polyaspartic acid is obtained in neutralized form as the sodium salt. Depending on the production process, the molecular weights vary between 2000-3000 g/mol or between 5000-6000 g/mol. Adjustment of the polymer structure or of the molecular weight to specific application requirements by specific process changes is not possible or only to a very limited extent.

WO 2011/001170 describes cleaning compositions for machine dishwashing comprising polyaspartic acid, a liquid nonionic surfactant and at least one solid nonionic surfactant, but the preparation of the polyaspartic acid is not described. Detergent and cleaning compositions are described in WO 2009/095645 as scale inhibitors, which comprise subsequently modified polyaspartic acids, having polyaspartic acid as backbone. The modified polyaspartic acids are obtained by reacting polyaspartic acid or polysuccinimide with PO/PE block copolymers, polyethyleneimine or adenosine triphosphate. Such a polyaspartic acid backbone can be adjusted in terms of its molecular weight only with difficulty, if at all. WO 95/021882 describes the preparation of polyaspartic acids by reaction of maleic acid, citric acid monohydrate, ammonia and hexanediamine. There is no description of use of the polymers in detergent compositions, dishwashing compositions or washing compositions.

It was therefore an object of the invention to provide a process for preparing polymers which

(1) can be used as additive in cleaning compositions, in washing compositions such as dishwashing compositions, in particular as additive to phosphate-free cleaning compositions and washing compositions for machine dishwashing, and as additive to liquid and solid detergents, and for the purposes of scale inhibition and/or dispersion in water-conducting systems,
(2) are adjustable in terms of their polymer structure and their molecular weight in a readily variable manner, and
(3) are biodegradable.

This object was achieved by the present invention according to the claims and the description and examples which follow.

The present invention describes, inter alia, preparation methods for modified polyaspartic acids which are readily adjustable in terms of their molecular weight and biodegradable and are of good suitability as an additive in cleaning, dishwashing and detergent compositions. They also have very good dispersant, scale inhibitor and spot inhibition properties.

The present invention therefore relates to processes for preparing modified polyaspartic acids or salts thereof, comprising the following steps:

(i) polycondensation of
(a) 50 to 98 mol %, preferably 60 to 95 mol % and more preferably 70 to 95 mol % of aspartic acid,
(b) 1 to 49 mol %, preferably 3 to 40 mol % and more preferably 5 to 30 mol % of at least one compound containing carboxyl groups, and
(c) 1 to 30 mol %, preferably 1 to 25 mol % and more preferably 2 to 20 mol % of a diamine or an amino alcohol,
at a temperature of 100 to 270° C. for 1 minute to 50 hours, where (b) is not aspartic acid;
   (ii) subsequent hydrolysis of the cocondensates with addition of a base; and
   (iii) optional acidification of the salt of polyaspartic acid obtained in (ii) with mineral acids, for example sulfuric acid or hydrochloric acid.

The optional step (iii) of acidification of the polyaspartic acid salt in the process of the invention serves to obtain the polyaspartic acid in acid form and can be carried out in a manner known to those skilled in the art and as is shown here by way of example. In the case that only the salt of polyaspartic acid is desired, for example, as intermediate, step (iii) in the context of the present invention can be omitted. If, in the context of the present invention, polyaspartic acid is in question, this also comprises accordingly its corresponding salts which are obtainable or are obtained according to step (ii) of the preparation process of the invention and which are recognized by those skilled in the art.

Aspartic acid (a) used in the context of the inventive preparation of the modified polyaspartic acid may be either L- or D-aspartic acid, and DL-aspartic acid. Preference is given to using L-aspartic acid.

Carboxyl-containing compound (b) used in the context of the inventive preparation of the modified polyaspartic acid may, inter alia, be a carboxylic acid (monocarboxylic acid or polycarboxylic acid), a hydroxycarboxylic acid and/or an amino acid (excluding aspartic acid). Such carboxylic acids or hydroxycarboxylic acids are preferably polybasic. In this connection, it is thus possible to use, in the inventive preparation of the modified polyaspartic acid, polybasic carboxylic acids, for example oxalic acid, adipic acid, fumaric acid, maleic acid, itaconic acid, aconitic acid, succinic acid, malonic acid, suberic acid, azelaic acid, diglycolic acid, glutaric acid, C₁-C₂₆ alkylsuccinic acids (e.g. octylsuccinic acid). C₂-C₂₆ alkenylsuccinic acids (e.g. octenylsuccinic acid), propane-1,2,3-tricarboxylic acid, propane-1,1,3,3-tetracarboxylic acid, ethane-1,1,2,2-tetracarboxylic acid, butane-1,2,3,4-tetracarboxylic acid, propane-1,2,2,3-tetracarboxylic acid, or pentane-1,3,3,5-tetracarboxylic acid. In addition, it is possible in this context to use polybasic hydroxycarboxylic acids, for example citric acid, isocitric acid, mucic acid, tartaric acid, tartronic acid, or malic acid. Amino acids used in this connection may include aminocarboxylic acids (e.g. glutamic acid, cysteine), basic diaminocarboxylic acids (e.g. lysine, arginine, histidine, aminocaprolactam), uncharged amino acids (e.g. glycine, alanine, valine, leucine, isoleucine, methionine, cysteine, norleucine, caprolactam, asparagine, isoasparagine, glutamine, isoglutamine), aminosulfonic acids (e.g. taurine), hydroxy amino acids (e.g. hydroxyproline, serine, threonine), iminocarboxylic acids (e.g. proline, iminodiacetic acid), or aromatic or heterocyclic amino acids (e.g. anthranilic acid, tryptophan, tyrosine, histidine), but not aspartic acid. Preferred carboxyl-containing compounds (b) in the context of the inventive preparation of the modified polyaspartic acids are butane-1,2,3,4-tetracarboxylic acid, citric acid, glycine, glutamic acid, itaconic acid, succinic acid, taurine, maleic acid and glutaric acid, more preferably butane-1,2,3,4-tetracarboxylic acid, citric acid, glycine and glutamic acid.

Useful diamines (c) in the context of the inventive preparation of the modified polyaspartic acid include all diamines having two primary amino groups, for example:

aliphatic linear: ethane-1,2-diamine, propane-1,3-diamine, butane-1,4-diamine, pentane-1,5-diamine, hexane-1,6-diamine, heptane-1,7-diamine, octane-1,8-diamine;
aliphatic branched: butane-1,2-diamine, propane-1,2-diamine, 2,2-dimethylpropane-1,3-diamine, 2-methylpentane-1,5-diamine, 2,2,4-trimethylhexane-1,6-diamine, 2,4,4-trimethylhexane-1,6-diamine, 2-butyl-2-ethylpentane-1,5-diamine;
aliphatic cyclic: 3-(aminomethyl)-3,5,5-trimethylcyclohexanamine, 4-[(4-aminocyclohexyl)methyl]cyclohexanamine, 4-[(4-amino-3-methyl-cyclohexyl)methyl]-2-methylcyclohexanamine, 4-methylcyclohexane-1,3-diamine, 2-methylcyclohexane-1,3-diamine; polyamines and polyetheramines: N′-(2-aminoethyl)ethane-1,2-diamine, N′-(3-aminopropyl)propane-1,3-diamine, N′-(2-aminoethyl)propane-1,3-diamine. N′-(3-aminopropyl)butane-1,4-diamine, N,N′-bis(3-aminopropyl)butane-1,4-diamine, N′-[2-(3-aminopropylamino)ethyl]propane-1,3-diamine, N′-(3-aminopropyl)-N-methylpropane-1,3-diamine, 2-[2-(2-aminoethoxy)ethoxy]ethanamine], 3-[2-[2-(3-aminopropoxy)ethoxy]ethoxy]propan-1-amine, 3-[4-(3-aminopropoxy)butoxy]propan-1-amine, and polyetheramines of the formula (I):

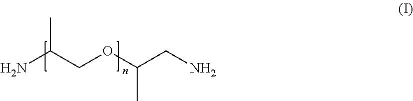

where n is 1 to 10, preferably 2 to 7.

Useful amino alcohols (c) in the context of the present invention include, for example, amino hydroxyl compounds having a primary amino group and a hydroxyl group. Such amino hydroxyl compounds (c) may, for example, be selected from the group consisting of monoethanolamine, 3-aminopropan-1-ol, 1-aminopropan-2-ol, 5-aminopentan-1-ol and 2-(2-aminoethoxy)ethanol. Bases used in step (ii) in the hydrolysis of the cocondensates in the inventive preparation of the modified polyaspartic acids may include: alkali metal and alkaline earth metal bases such as sodium hydroxide solution, potassium hydroxide solution, calcium hydroxide or barium hydroxide; carbonates such as sodium carbonate and potassium carbonate; ammonia and primary, secondary or tertiary amines; other bases having primary, secondary or tertiary amino groups. In the context of the present invention, preference is given to sodium hydroxide solution or ammonium hydroxide.

The inventive preparation of the modified polyaspartic acids is generally effected via a polycondensation of aspartic acid (a) with at least one carboxyl-containing compounds (not aspartic acid) (b), a diamine or amino alcohol (c), subsequent hydrolysis of the cocondensates with addition of a base, and—to obtain the acid from the salt—optionally acidification as detailed and described hereinabove and -below. There follows a description by way of example of the inventive preparation of the modified polyaspartic acids. This preparation description must not be understood in a limiting manner with regard to the modified polyaspartic acids to be used in accordance with the invention. The modified polyaspartic acids or salts thereof to be prepared in accordance with the invention—each of which likewise forms part of the subject matter of the present invention—include, as well as those which are prepared or obtained by the preparation process of the invention, those which are preparable or obtainable by the preparation process of the invention. In connection with the present invention, the modified polyaspartic acids can be prepared, for example, by polycondensation of components (a), (b), (c), i.e. aspartic acid (a), at least one carboxyl-containing compound (b), a diamine or an amino alcohol (c), in the molar ratios as described here. The polycondensation in step (i) of the preparation process of the invention can be effected at temperatures of 100° C. to 270° C., preferably at 120° C. to 250° C., more preferably at 180° C. to 220° C. The condensation (heat treatment) is preferably conducted under reduced pressure or under an inert gas atmosphere (e.g. N₂, argon). Alternatively, the condensation can be effected under elevated pressure or in a gas stream, e.g. carbon dioxide, air, oxygen or steam. Depending on the reaction conditions selected, the reaction times for the condensation, in accordance with the invention, are generally between 1 minute and 50 hours, preferably between 5 to 8 hours. The polycondensation can be conducted, for example, in the solid phase by first preparing an aqueous solution or suspension of aspartic acid (a), at least one carboxyl-containing compound (b), a diamine or an amino alcohol (c), and concentrating the solution to dryness. In the course of this, condensation may already set in. Examples of suitable reaction apparatus for the condensation include heating bands, kneaders, mixers, paddle dryers, hard phase dryers, extruders, rotary tube ovens and other heatable devices in which the condensation of solids can be conducted with removal of water of reaction. Polycondensates having low molecular weight can be produced in pressure-tight sealed vessels as well, in which the water of reaction present is removed only partially, if at all. It is also possible to conduct the polycondensation by means of infrared radiation or microwave radiation. Another possibility is acid-catalyzed polycondensation, for example with inorganic acids of phosphorus or sulfur, or with hydrogen halides. Acid-catalyzed polycondensations of this kind are also described in general terms, for example, in DE 4221875.6. The optional acidification of the salt of the modified polyaspartic acid can be effected, for example, by adding a defined amount of a concentrated or diluted mineral acid, for example sulfuric acid or hydrochloric acid, to an aqueous sodium salt solution of the modified polyaspartic acid. The acidification can also be effected by treatment with an acidic ion exchanger, for example Amberlite IR 120 (hydrogen form), by allowing the aqueous sodium salt solution of the modified polyaspartic acid to flow through a column packed with the ion exchanger.

It can also be advantageous to add small amounts of methanesulfonic acid (for example 0.1 to 20 mol %, based on the amount used (in mol) of aspartic acid) in the polycondensation. Methanesulfonic acid, like polyaspartic acid, is biodegradable. Small amounts of methanesulfonic acid can remain in the polymer product without being detrimental to the environment and without affecting performance in the numerous applications. There is no need for any complex workup or purification. Yield losses resulting from the workup are avoided.

In the thermal polycondensation of aspartic acid (a) with a carboxyl-containing compounds (b) and a diamine or an amino alcohol (c) (with or without methanesulfonic acid) as described herein, the polycondensate is generally obtained in the form of the water-insoluble modified polyaspartimides. The cocondensates of aspartic acid can be purified to free them of the unconverted starting materials, for example, by comminuting the condensation product and extracting it with water at temperatures of 10 to 100° C. This leaches out the unconverted feedstocks and washes out any methanesulfonic acid used. Unconverted aspartic acid can be leached out easily by extracting with 1 N hydrochloric acid.

The modified polyaspartic acids are preferably obtained from the polycondensates by slurrying the polycocondensates in water and hydrolyzing and neutralizing them at temperatures preferably in the range from 0 to 90° C. with addition of a base. The hydrolysis and neutralization preferably take place at pH values of 8 to 10. Useful bases include, for example, alkali metal and alkaline earth metal bases such as sodium hydroxide solution, potassium hydroxide solution, calcium hydroxide or barium hydroxide. Useful bases also include, for example, carbonates such as sodium carbonate and potassium carbonate. Other suitable bases are ammonia and primary, secondary or tertiary amines, and other bases having primary, secondary or tertiary amino groups. In the case of use of amines for conversion of polyaspartimide, the amines, because of their high reactivity, may be bound to the polyaspartic acid either in salt form or amide form. In the case of treatment with bases, partly or fully neutralized polycocondensates are obtained, which, in accordance with the use in the preceding polycondensation, comprise 50 to 98 mol %, preferably 60 to 95 mol % and more preferably 70 to 95 mol % of aspartic acid, 1 to 49 mol %, preferably 3 to 40 mol % and more preferably 5 to 30 mol % of a carboxyl-containing compound, and 1 to 30 mol %, preferably 1 to 25 mol % and more preferably 2 to 20 mol % of a diamine or an amino alcohol, in the form of the salts corresponding to the bases, for example in the form of the alkali metal, alkaline earth metal or ammonium salts.

The molar ratio of the carboxyl-containing compound (b) for use in the polycondensation (i) in the preparation process of the invention to the diamine or amino alcohol (c) is between 5:1 and 1:1.5, preferably between 3:1 and 1:1.2, more preferably between 3:1 and 1:1 or 2:1 and 1:1. The ratio may, inter alia, be 1:1, 2:1 or 2.67:1, as shown here by way of example.

The present invention further relates to modified polyaspartic acids which are prepared or obtained by the preparation process of the invention, or are preparable or obtainable thereby.

The modified polyaspartic acids or salts thereof to be used or prepared/preparable in accordance with the invention can be used in the form of an aqueous solution or in solid form, for example in powder form or granular form. As is known to those skilled in the art, the powder or granular form may be obtained, for example, by spray-drying, spray granulation, fluidized bed spray granulation, drum drying or freeze-drying of the aqueous solution of the polyaspartic acids or salts thereof.

The modified polyaspartic acids preparable in accordance with the invention are notable, inter alia, for their very good scale-inhibiting and dispersing action, specifically with respect to both inorganic and organic deposits. In particular, they inhibit deposits of calcium carbonate and magnesium carbonate and calcium phosphates and phosphonates and magnesium phosphates and phosphonates. In addition, they prevent deposits which originate from the soil constituents of a rinse liquor, for example, fat, protein and starch deposits.

The present invention therefore also relates to the use of modified polyaspartic acids preparable in accordance with the invention as scale inhibitors or dispersants. The modified polyaspartic acids can be used either as additive in cleaning compositions, dishwashing compositions (particularly machine dishwashing compositions) or detergents or as scale inhibitors or dispersants in water-conducting systems as detailed and described here.

The present invention also relates to compositions—particularly cleaning compositions, dishwashing compositions and detergent compositions—comprising modified polyaspartic acids preparable or obtainable by the process of the invention. One embodiment of the present invention relates in particular to dishwashing compositions for machine dishwashing comprising the modified polyaspartic acids as described here.

Such compositions comprise, in addition to the modified polyaspartic acids of the invention, further constituents such as solvents, surfactants or complexing agents.

The modified polyaspartic acids of the invention can be incorporated directly into the formulations (mixtures) in their various administration forms by the methods known to those skilled in the art. Mention should be made here by way of example of solid formulations such as powders, tablets, gel and liquid formulations. The machine dishwashing compositions of the invention, and the other cleaning, dishwashing and detergent compositions, may be provided in liquid, gel or solid form, in monophasic or polyphasic form, as tablets or in the form of other dose units, and in packed or unpacked form. In this context, the modified polyaspartic acids preparable in accordance with the invention can be used either in multicomponent product systems (separate use of detergent, rinse aid and regenerating salt) or in those dishwashing agents in which the functions of detergent, rinse aid and regenerating salt are combined in one product (e.g. 3-in-1 products, 6-in-1 products, 9-in-1 products, all-in-one products).

The dishwashing compositions of the invention comprise
(A_{S}) 1-20 wt %, preferably 1-15 wt % and more preferably 2-12 wt % of at least one modified polyaspartic acid described here and for use in accordance with the invention;
(B_{S}) 0-50 wt % of complexing agents;
(C_{S}) 0.1-80 wt % of builders and/or cobuilders;
(D_{S}) 0.1-20 wt % of nonionic surfactants;
(E_{S}) 0-30 wt % of bleaches, bleach activators and bleach catalysts;
(F_{S}) 0-8 wt % of enzymes; and
(G_{S}) 0-50 wt % of additives.

The sum total of (A_{S}) to (G_{S}) is 100 wt %.

The dishwashing compositions of the invention is especially suitable as dishwashing composition for machine dishwashing. In one embodiment, the dishwashing composition of the invention is therefore a machine dishwashing composition.

Complexing agents (B_{S}) used may be, for example: nitrilotriacetic acid, ethylenediaminetetraacetic acid, diethylenetriaminepentaacetic acid, hydroxyethylethylenediaminetriacetic acid, methylglycinediacetic acid, glutamic acid diacetic acid, iminodisuccinic acid, hydroxyiminodisuccinic acid, ethylenediaminedisuccinic acid, aspartic acid diacetic acid, and also salts thereof in each case. Preferred complexing agents (B_{S}) are methylglycinediacetic acid and glutamic acid diacetic acid and salts thereof. Particularly preferred complexing agents (B_{S}) are methylglycinediacetic acid and salts thereof. Preference is given in accordance with the invention to 3 to 50 wt % of complexing agent (B_{S}).

Builders and/or cobuilders (C_{S}) used may be, in particular, water-soluble or water-insoluble substances having the main task of binding calcium and magnesium ions. These may be low molecular weight carboxylic acids and also salts thereof such as alkali metal citrates, in particular anhydrous trisodium citrate or trisodium citrate dihydrate, alkali metal succinates, alkali metal malonates, fatty acid sulfonates, oxydisuccinate, alkyl or alkenyl disuccinates, gluconic acids, oxadiacetates, carboxymethyloxysuccinates, tartrate monosuccinate, tartrate disuccinate, tartrate monoacetate, tartrate diacetate and α-hydroxypropionic acid.

A further substance class with cobuilder properties which may be present in the cleaning compositions of the invention is that of the phosphonates. These are in particular hydroxyalkane phosphonates or aminoalkane phosphonates. Among the hydroxyalkane phosphonates, 1-hydroxyethane 1,1-diphosphonate (HEDP) is of particular significance as cobuilder. The latter is preferably used as the sodium salt, where the disodium salt gives a neutral reaction and the tetrasodium salt an alkaline reaction (pH 9). Suitable aminoalkane phosphonates are preferably ethylenediamine tetramethylenephosphonate (EDTMP), diethylenetriamine pentamethylenephosphonate (DTPMP) and also the higher homologs thereof. They are preferably used in the form of the neutrally reacting sodium salts, for example, as hexasodium salt of EDTMP or as heptasodium and octasodium salt of DTPMP. The builder used in this case is from the class of the phosphonates, preferably HEDP. Aminoalkane phosphonates additionally have a pronounced heavy metal binding capacity. Accordingly, it may be preferable to use aminoalkane phosphonates, particularly DTPMP, or mixtures of the phosphonates mentioned, particularly if the compositions also comprise bleach.

Silicates may be used, inter alia, as builders. Crystalline sheet silicates having the general formula NaMSiₓO₂ₓ₊₁ yH₂O may be present, where M is sodium or hydrogen, x is a number from 1.9 to 22, preferably from 1.9 to 4, particularly preferred values for x being 2, 3 or 4, and y is a number from 0 to 33, preferably 0 to 20. In addition, amorphous sodium silicates having an [SiO]₂:Na₂O ratio of 1 to 3.5, preferably 1.6 to 3 and in particular 2 to 2.8 may be used.

Furthermore, builders or co-builders (C_{S}) used in the context of the dishwashing composition of the invention may be carbonates and hydrogencarbonates, among which preference is given to the alkali metal salts, particularly sodium salts.

Furthermore, the cobuilders used may be homopolymers and copolymers of acrylic acid or methacrylic acid preferably having a weight-average molar mass of 2000 to 50 000 g/mol. Suitable comonomers are in particular monoethylenically unsaturated dicarboxylic acids such as maleic acid, fumaric acid and itaconic acid and also anhydrides thereof such as maleic anhydride. Also suitable are comonomers containing sulfonic acid groups such as 2-acrylamido-2-methylpropanesulfonic acid, allylsulfonic acid and vinylsulfonic acid. Hydrophobic comonomers are also suitable such as, for example, isobutene, diisobutene, styrene, alpha-olefins with 10 or more carbon atoms. Hydrophilic monomers having hydroxyl functions or alkylene oxide groups may also be used as comonomers. Examples include: allyl alcohol and isoprenol and also alkoxylates thereof and methoxypolyethylene glycol (meth)acrylate.

Preferred amounts of builders and/or cobuilders in the context of the dishwashing composition of the invention are 5 to 80 wt %, more preferably 10 to 75 wt %, 15 to 70 wt % or 15 to 65 wt %.

Nonionic surfactants (Ds) used in the context of the dishwashing composition of the invention may be, for example, weakly foaming or low foaming nonionic surfactants. These may be present in proportions of 0.1 to 20 wt %, preferably 0.1 to 15 wt %, more preferably 0.25 to 10 wt % or 0.5 to 10 wt %. Suitable nonionic surfactants include surfactants of the general formula (II)

R¹—O—(CH₂CH₂O)ₐ—(CHR²CH₂O)_{b}—R³ (II)

in which R¹ is a linear or branched alkyl radical having 8 to 22 carbon atoms,
R² and R³ are each independently hydrogen or a linear or branched alkyl radical having 1 to 10 carbon atoms or H, where R² is preferably methyl, and
a and b are each independently 0 to 300. Preferably, a=1 to 100 and b=0 to 30.

Also suitable in the context of the present invention are surfactants of formula (III)

R⁴—O—[CH₂CH(CH₃)O]_{c}[CH₂CH₂O]_{d}[CH₂CH(CH₃)O]ₑCH₂CH(OH)R⁵ (III)

in which R⁴ is a linear or branched aliphatic hydrocarbyl radical having 4 to 22 carbon atoms or mixtures thereof,
R⁵ is a linear or branched hydrocarbyl radical having 2 to 26 carbon atoms or refers to mixtures thereof,
c and e have values between 0 and 40, and
d is a value of at least 15.

Also suitable in the context of the present invention are surfactants of formula (IV)

R⁶O—(CH₂CHR⁷O)_{f}(CH₂CH₂O)_{g}(CH₂CHR⁸O)ₕ—CO—R⁶ (IV)

in which R⁶ is a branched or unbranched alkyl radical having 8 to 16 carbon atoms,
R⁷, R⁸ are each independently H or a branched or unbranched alkyl radical having 1 to 5 carbon atoms,
R⁶ is an unbranched alkyl radical having 5 to 17 carbon atoms,
f, h are each independently a number from 1 to 5, and
g is a number from 13 to 35.

The surfactants of the formulae (II), (III) and (IV) may be either random copolymers or block copolymers; they are preferably block copolymers.

Furthermore, in the context of the present invention, di- and multi-block copolymers formed from ethylene oxide (EO) and propylene oxide (PO) may be used, which are commercially available, for example, under the Pluronic® (BASF SE) or Tetronic® name (BASF Corporation). Furthermore, reaction products of sorbitan esters with ethylene oxide and/or propylene oxide can be used. Amine oxides or alkyl glycosides are also suitable. An overview of suitable nonionic surfactants are disclosed in EP-A851 023 and DE-A 198 19 187.

Mixtures of two or more different nonionic surfactants may also be present. The dishwashing compositions of the invention may further comprise anionic or zwitterionic surfactants, preferably in a mixture with nonionic surfactants. Suitable anionic and zwitterionic surfactants are likewise specified in EP-A851 023 and DE-A 198 19 187.

Bleaches and bleach activators (E_{S}) used in the context of the dishwashing compositions of the invention may be representatives known to those skilled in the art. Bleaches are subdivided into oxygen bleaches and chlorine bleaches. Oxygen bleaches used are alkali metal perborates and hydrates thereof, and also alkali metal percarbonates. Preferred bleaches in this context are sodium perborate in the form of the mono- or tetrahydrate, sodium percarbonate or the hydrates of sodium percarbonate. Likewise useable as oxygen bleaches are persulfates and hydrogen peroxide. Typical oxygen bleaches are also organic peracids such as perbenzoic acid, peroxy-alpha-naphthoic acid, peroxylauric acid, peroxystearic acid, phthalimidoperoxycaproic acid, 1,12-diperoxydodecanedioic acid, 1,9-diperoxyazelaic acid, diperoxoisophthalic acid or 2-decyldiperoxybutane-1,4-dioic acid. In addition, the following oxygen bleaches may also be used in the dishwashing composition: cationic peroxy acids, which are described in the patent applications U.S. Pat. No. 5,422,028, U.S. Pat. No. 5,294,362 and U.S. Pat. No. 5,292,447, and sulfonylperoxy acids, which are described in the patent application U.S. Pat. No. 5,039,447. Oxygen bleaches may be used generally in amounts of 0.1 to 30 wt %, preferably of 1 to 20 wt %, more preferably of 3 to 15 wt %, based on the overall dishwashing composition.

Chlorine bleaches and the combination of chlorine bleaches with peroxide bleaches may also be used in the context of the dishwashing compositions of the invention. Known chlorine bleaches are, for example, 1,3-dichloro-5,5-dimethylhydantoin, N-chlorosulfamide, chloramine T, dichloramine T, chloramine B, N,N′-dichlorobenzoyl urea, p-toluenesulfonedichloroamide or trichloroethylamine. Preferred chlorine bleaches in this case are sodium hypochlorite, calcium hypochlorite, potassium hypochlorite, magnesium hypochlorite, potassium dichloroisocyanurate or sodium dichloroisocyanurate. Chlorine bleaches may be used in this context in amounts of 0.1 to 30 wt %, preferably 0.1 to 20 wt %, preferably 0.2 to 10 wt %, more preferably 0.3 to 8 wt %, based on the overall dishwashing composition.

In addition, small amounts of bleach stabilizers, for example phosphonates, borates, metaborates, metasilicates or magnesium salts, may be added.

Bleach activators in the context of the present invention can be compounds which, under perhydrolysis conditions, give rise to aliphatic peroxocarboxylic acids having preferably 1 to 10 carbon atoms, in particular 2 to 4 carbon atoms, and/or substituted perbenzoic acid. In this case, suitable compounds comprise, inter alia, one or more N or O-acyl groups and/or optionally substituted benzoyl groups, for example substances from the class of the anhydrides, esters, imides, acylated imidazoles or oximes. Examples are tetraacetylethylenediamine (TAED), tetraacetylmethylenediamine (TAM D), tetraacetylglycoluril (TAGU), tetraacetylhexylenediamine (TAHD). N-acylimides such as N-nonanoylsuccinimide (NOSI), acylated phenol sulfonates such as n-nonanoyl- or isononanoyloxybenzenesulfonate (n- or iso-NOBS), pentaacetylglucose (PAG), 1,5-diacetyl-2,2-dioxohexahydro-1,3,5-triazine (DADHT) or isatoic anhydride (ISA). Also suitable as bleach activators are nitrile quats such as N-methylmorpholinium acetonitrile salts (MMA salts) or trimethylammonium acetonitrile salts (TMAQ salts). Preferred suitable bleach activators are from the group consisting of polyacylated alkylenediamines, more preferably TAED. N-acylimides, more preferably NOSI, acylated phenolsulfonates, more preferably n- or iso-NOBS, MMA, and TMAQ. Bleach activators may be used in the context of the present invention in amounts of 0.1 to 30 wt %, preferably 0.1 to 10 wt %, preferably 1 to 9 wt %, more preferably 1.5 to 8 wt %, based on the overall dishwashing composition.

In addition to the conventional bleach activators or in place of them, so-called bleach catalysts may also be incorporated in rinse aid particles. These substances are bleach-enhancing transition metal salts or transition metal complexes such as salen complexes or carbonyl complexes of manganese, iron, cobalt, ruthenium or molybdenum. Also usable as bleach catalysts are complexes of manganese, iron, cobalt, ruthenium, molybdenum, titanium, vanadium and copper with nitrogen-containing tripod ligands and also amine complexes of cobalt, iron, copper and ruthenium.

As component (F_{S}), the dishwashing compositions of the invention may comprise 0 to 8 wt % of enzymes. If the dishwashing compositions comprise enzymes, they comprise them preferably in amounts of 0.1 to 8 wt %. Enzymes may be added to the dishwashing composition in order to increase the cleaning performance or to ensure the same quality of cleaning performance under milder conditions (e.g. at low temperatures). The enzymes can be used in free form or a form chemically or physically immobilized on a support or in encapsulated form. The enzymes used most frequently in this context include lipases, amylases, cellulases and proteases. In addition, it is also possible, for example, to use esterases, pectinases, lactases and peroxidases. Preference is given in accordance with the invention to using amylases and proteases.

In the context of the dishwashing compositions of the invention, additives (Gs) used may be, for example, anionic or zwitterionic surfactants, alkali carriers, polymeric dispersants, corrosion inhibitors, defoamers, dyes, fragrances, fillers, tablet disintegrants, organic solvents, tableting aids, disintegrants, thickeners, solubilizers or water. The alkali carriers used may be, for example, in addition to the ammonium or alkali metal carbonates already mentioned as builder substances, ammonium or alkali metal hydrogencarbonates and ammonium or alkali metal sesguicarbonates, and also ammonium or alkali metal hydroxides, ammonium or alkali metal silicates and ammonium or alkali metal metasilicates and also mixtures of the aforementioned substances.

The corrosion inhibitors used may be, inter alia, silver anticorrosives from the group of the triazoles, the benzotriazoles, the bisbenzotriazoles, the aminotriazoles, the alkylaminotriazoles and the transition metal salts or complexes.

To prevent glass corrosion, which is noticeable as cloudiness, iridescence, streaks and lines on the glasses, preference is given to using glass corrosion inhibitors. Preferred glass corrosion inhibitors are, for example, magnesium, zinc and bismuth salts and complexes.

Paraffin oils and silicone oils may optionally be used in accordance with the invention as defoamers and to protect plastics and metal surfaces. Defoamers are used preferably in proportions of 0.001 wt % to 5 wt %. In addition, dyes, for example patent blue, preservatives, for example Kathon CG, perfumes and other fragrances may be added to the inventive cleaning formulation.

In the context of the dishwashing compositions of the invention, an example of a suitable filler is sodium sulfate.

In the context of the present invention, further possible additives include amphoteric and cationic polymers.

In one embodiment, the dishwashing composition of the invention is phosphate-free. The term “phosphate-free” in this context also encompasses those dishwashing compositions which comprise essentially no phosphate, i.e. comprise phosphate in technically ineffective amounts. In particular, this encompasses compositions having less than 1.0 wt %, preferably less than 0.5 wt %, of phosphate, based on the overall composition.

The present invention further relates to cleaning compositions and detergent compositions comprising modified polyaspartic acids preparable in accordance with the invention. The detergent and cleaning compositions in which the modified polyaspartic acids of the invention can be used may be in pulverulent, granular, tablet, paste, gel or liquid form. Examples thereof are heavy-duty detergents, mild-action detergents, color detergents, wool detergents, curtain detergents, modular detergents, washing tablets, bar soaps, stain removal salts, laundry starches and stiffeners, and ironing aids. They comprise at least 0.1 wt %, preferably between 0.1 and 10 wt % and more preferably 0.2 to 5 wt % of modified polyaspartic acids preparable in accordance with the invention. The compositions are to be adapted according to their intended use in terms of their composition to the type of textiles to be washed or the surfaces to be cleaned. They comprise conventional detergent and cleaning ingredients, as correspond to the prior art. Representative examples of such detergent and cleaning ingredients and compositions are described below.

The present invention further relates to detergent and cleaning compositions in liquid or gel form, comprising
(A_{L}) 0.1 to 20 wt % of at least one modified polyaspartic acid described here and for use in accordance with the invention,
(B_{L}) 1 to 80 wt % of surfactants,
(C_{L}) 0.1 to 50 wt % of builders, cobuilders and/or complexing agents,
(D_{L}) 0 to 20 wt % of bleach system,
(E_{L}) 0.1 to 60 wt % of detergent or cleaning composition ingredients, i.e. other customary ingredients such as alkali carriers, defoamers, enzymes (e.g. lipases, proteases, amylases, cellulases), dyes, fragrances, perfume carriers, graying inhibitors, dye transfer inhibitors, color protection additives, fiber protection additives, optical brighteners, soil release polyesters, corrosion inhibitors, bactericides and preservatives, organic solvents, solubilizers, pH modifiers, hydrotropes, thickeners, rheology modifiers and/or alkanolamines, and
(F_{L}) 0 to 98.7 wt % of water.

The sum total of (A_{L}) to (F_{L}) is 100 wt %.

The quantitative ratios of the individual components are adjusted by a person skilled in the art depending on the particular field of use of the detergent and cleaning composition in liquid and gel form.

The present invention further relates to solid detergent and cleaning compositions comprising
(A_{F}) 0.1 to 20 wt % of at least one modified polyaspartic acid described here and for use in accordance with the invention,
(B_{F}) 1 to 50 wt % of surfactants,
(C_{F}) 0.1 to 70 wt % of builders, cobuilders and/or complexing agents,
(D_{F}) 0 to 30 wt % of bleach system, and
(E_{F}) 0.1 to 70 wt % of detergent or cleaning composition ingredients, i.e. other customary ingredients such as modifiers (e.g. sodium sulfate), defoamers, enzymes (e.g. lipases, proteases, amylases, cellulases), dyes, fragrances, perfume carriers, graying inhibitors, dye transfer inhibitors, color protection additives, fiber protection additives, optical brighteners, soil release polyesters, corrosion inhibitors, bactericides and preservatives, dissolution promoters, disintegrants, process auxiliaries and/or water.

The sum total of components (A_{F}) to (E_{F}) is 100 wt %.

The solid detergent and cleaning compositions can be present, for example, in the form of powder, granules, extrudates or tablets.

The quantitative ratios of the individual components are adjusted by a person skilled in the art depending on the particular field of use of the solid detergent and cleaning composition.

In the context of the present invention, surfactants (B_{L} or B_{F}) used may be, for example, nonionic surfactants (NIS). The nonionic surfactants used are preferably alkoxylated, advantageously ethoxylated, in particular primary alcohols having preferably 8 to 18 carbon atoms and, on average, 1 to 12 mol of ethylene oxide (EO) per mole of alcohol, in which the alcohol radical can be linear or preferably 2-methyl-branched and/or can comprise linear and methyl-branched residues in a mixture, as customarily present in oxo alcohol residues. In particular, however, preference is given to alcohol ethoxylates with linear or branched residues from alcohols of native or petrochemical origin having 12 to 18 carbon atoms, for example from coconut alcohol, palm alcohol, tallow fat alcohol or oleyl alcohol, and, on average, 2 to 8 EO per mole of alcohol. The preferred ethoxylated alcohols include, for example, C₁₂-C₁₄-alcohols with 3 ED, 5 EO, 7 EO or 9 ED, C₉-C₁₁-alcohol with 7 EO, C₁₃-C₁₈-alcohols with 3 EO, 5 EO, 7 EO or 9 EO, C₁₂-C₁₈-alcohols with 3 EO, 5 EO, 7 EO or 9 EO and mixtures of these, such as mixtures of C₁₂-C₁₄-alcohol with 3 EO and C₁₂-C₁₈-alcohol with 7 EO, 2 propylheptanol with 3 to 9 EO. Mixtures of short-chain alcohol ethoxylates (e.g. 2-propylheptanol×7 ED) and long-chain alcohol ethoxylates (e.g. C16,18×7 EO). The stated degrees of ethoxylation are statistical average values (number-average, Mn) which can be an integer or a fraction for a specific product. Preferred alcohol ethoxylates have a narrowed homolog distribution (narrow range ethoxylates, NRE). In addition to these nonionic surfactants, fatty alcohols with more than 12 EO can also be used. Examples thereof are tallow fatty alcohol with 14 ED, 25 EO, 30 ED or 40 EO. It is also possible to use nonionic surfactants which comprise ethylene oxide (EO) and propylene oxide (PO) groups together in the molecule. In this context, it is possible to use block copolymers having EO-PO block units or PO-EO block units, but also EO-PO-EO copolymers or PO-EO-PO copolymers. It is of course also possible to use nonionic surfactants with mixed alkoxylation, in which EO and PO units are not distributed blockwise, but randomly. Such products are obtainable by the simultaneous action of ethylene oxide and propylene oxide on fatty alcohols.

In addition, as further nonionic surfactants, in accordance with the invention, it is also possible to use alkyl glycosides of the general formula (V)

R¹⁰O(G)ᵢ (V)

in which R¹⁰ is a primary straight-chain or methyl-branched, in particular 2-methyl-branched, aliphatic radical having 8 to 22, preferably 12 to 18 carbon atoms, and G is a glycoside unit having 5 or 6 carbon atoms, preferably glucose. The degree of oligomerization i, which indicates the distribution of monoglycosides and oligoglycosides, is any desired number between 1 and 10; preferably i is 1.2 to 1.4.

In the context of the present invention, a further class of nonionic surfactants used with preference, which are used either as the sole nonionic surfactant or in combination with other nonionic surfactants, is that of alkoxylated, preferably ethoxylated or ethoxylated and propoxylated fatty acid alkyl esters, preferably having 1 to 4 carbon atoms in the alkyl chain, in particular fatty acid methyl esters, as described, for example, in the Japanese patent application JP 58/217598 or which are preferably prepared by the process described in the international patent application WO 90/13533. Nonionic surfactants of the amine oxide type, for example N-cocoalkyl-N,N-dimethylamine oxide and N-tallow-alkyl-N,N-dihydroxyethylamine oxide, and the fatty acid alkanolamides may also be suitable in this context. The amount (weight) of these nonionic surfactants is preferably not more than that of the ethoxylated fatty alcohols, especially not more than half thereof.

Further suitable surfactants (B_{L} or B_{F}) are, in accordance with the invention, polyhydroxy fatty acid amides of formula (VI)

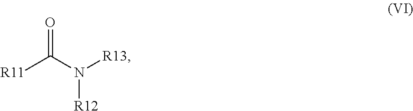

in which R11C(═O) is an aliphatic acyl radical having 6 to 22 carbon atoms, R12 is hydrogen, an alkyl or hydroxyalkyl radical having 1 to 4 carbon atoms and R13 is a linear or branched polyhydroxyalkyl radical having 3 to 10 carbon atoms and 3 to 10 hydroxyl groups. The polyhydroxy fatty acid amides are known substances which can typically be obtained by reductive amination of a reducing sugar with ammonia, an alkylamine or an alkanolamine and subsequent acylation with a fatty acid, a fatty acid alkyl ester or a fatty acid chloride. The group of the polyhydroxy fatty acid amides also includes compounds of the formula (VII) in this context

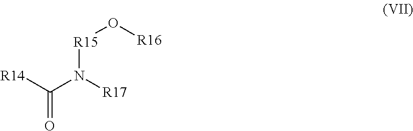

in which R14 is a linear or branched alkyl or alkenyl radical having 7 to 12 carbon atoms. R15 is a linear, branched or cyclic alkylene radical having 2 to 8 carbon atoms or an arylene radical having 6 to 8 carbon atoms and R16 is a linear, branched or cyclic alkyl radical or an aryl radical or an oxyalkyl radical having 1 to 8 carbon atoms, where C₁-C₄-alkyl or phenyl residues are preferred, and R17 is a linear polyhydroxyalkyl radical whose alkyl chain is substituted with at least two hydroxyl groups, or alkoxylated, preferably ethoxylated or propoxylated, derivatives of this radical. R17 is preferably obtained by reductive amination of a sugar, for example glucose, fructose, maltose, lactose, galactose, mannose or xylose. The N-alkoxy- or N-aryloxy-substituted compounds can then be converted to the desired polyhydroxy fatty acid amides, for example, according to WO 95/07331 by reaction with fatty acid methyl esters in the presence of an alkoxide as a catalyst

Surfactants (B_{L} or B_{F}) may, in accordance with the invention, also be anionic surfactants. In the context of the present invention, the anionic surfactants used may be those of the sulfonate and sulfate type, for example. Suitable surfactants of the sulfonate type are preferably C₉-C₁₃-alkylbenzenesulfonates, olefinsulfonates, i.e. mixtures of alkene- and hydroxyalkanesulfonates, and also disulfonates, as obtained, for example, from C₁₂-C₁₈-monoolefins with terminal or internal double bond by sulfonation with gaseous sulfur trioxide and subsequent alkaline or acidic hydrolysis of the sulfonation products. Also suitable are alkane sulfonates which are obtained from C₁₂-C₁₈-alkanes, for example by sulfochlorination or sulfoxidation with subsequent hydrolysis or neutralization. Likewise, the esters of α-sulfo fatty acids (ester sulfonates), for example the α-sulfonated methyl esters of hydrogenated coconut, palm kernel or tallow fatty acids, are also suitable. Further suitable anionic surfactants may, in accordance with the invention, be sulfated fatty acid glycerol esters. Fatty acid glycerol esters are to be understood to mean, inter alia, mono-, di- and triesters, and mixtures thereof, as obtained in the preparation by esterification of a monoglycerol with 1 to 3 mol of fatty acid or during the transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

The alk(en)yl sulfates are preferably the alkali metal and in particular the sodium salts of the sulfuric acid half-esters of C₁₂-C₁₈-fatty alcohols, for example of coconut fatty alcohol, tallow fatty alcohol, lauryl alcohol, myristyl alcohol, cetyl alcohol or stearyl alcohol or of the C₁₀-C₂₀-oxo alcohols and those half-esters of secondary alcohols of these chain lengths. Furthermore, preference is given to alk(en)yl sulfates of the specified chain length which comprise a synthetic, petrochemical-based straight-chain alkyl radical which have analogous degradation behavior to the appropriate compounds based on oleochemical raw materials. From a washing point of view, the C₁₂-C₁₆-alkyl sulfates and C₁₂-C₁₈-alkyl sulfates and also C₁₄-C₁₈-alkyl sulfates are preferred. 2,3-Alkyl sulfates, which are prepared, for example, in accordance with the US patent specifications 3,234,258 or 5,075,041 and can be obtained as commercial products from the Shell Oil Company under the name DAN®, are also suitable anionic surfactants. Also suitable are the sulfuric monoesters of the straight-chain or branched C₇-C₂₁-alcohols ethoxylated with 1 to 6 mol of ethylene oxide, such as 2-methyl-branched C₉-C₁₁-alcohols with on average 3.5 mol of ethylene oxide (EO) or C₁₂-C₁₈-fatty alcohols with 1 to 4 EO, inter alia. On account of their high foaming propensity, they are typically used in cleaning compositions only in relatively small amounts, for example in amounts of 1 to 5 wt %. In the context of the present invention, further suitable anionic surfactants are also the salts of alkylsulfosuccinic acid, which are also referred to as sulfosuccinates or as sulfosuccinic acid esters and which constitute monoesters and/or diesters of sulfosuccinic acid with alcohols, preferably fatty alcohols and in particular ethoxylated fatty alcohols. Preferred sulfosuccinates comprise C₈-C₁₈-fatty alcohol residues or mixtures thereof. Particularly preferred sulfosuccinates comprise a fatty alcohol radical derived from ethoxylated fatty alcohols. In this connection, particular preference is in turn given to sulfosuccinates whose fatty alcohol residues are derived from ethoxylated fatty alcohols with a narrow homolog distribution. It is likewise also possible to use alk(en)ylsuccinic acid having preferably 8 to 18 carbon atoms in the alk(en)yl chain or salts thereof.

Particularly preferred anionic surfactants are soaps. Saturated and unsaturated fatty acid soaps, such as the salts of lauric acid, myristic acid, palmitic acid, stearic acid, (hydrogenated) erucic acid and behenic acid, and also soap mixtures derived in particular from natural fatty acids, for example coconut, palm kernel, olive oil or tallow fatty acids, are suitable.

The anionic surfactants including the soaps can be present in accordance with the invention in the form of their sodium, potassium or ammonium salts, and also as soluble salts of organic bases, such as mono-, di- or triethanolamine. Preferably, the anionic surfactants are present in the form of their sodium or potassium salts, in particular in the form of the sodium salts.

In the context of the present invention, the surfactants (B_{L} or B_{F}) used may also be cationic surfactants. Particularly suitable cationic surfactants that may be mentioned here, for example, are:
C₇-C₂₅-alkylamines;
N,N-dimethyl-N-(hydroxy-C₇-C₂₅-alkyl)ammonium salts;
mono- and di(C₇-C₂₅-alkyl)dimethylammonium compounds quaternized with alkylating agents;
ester quats, in particular quaternary esterified mono-, di- and trialkanolamines which are esterified with C₈-C₂₂-carboxylic acids;
imidazoline quats, in particular 1-alkylimidazolinium salts of formulae VIII or IX

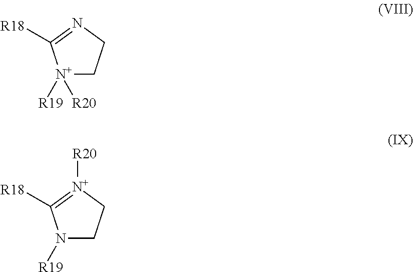

where the variables are each defined as follows:
R18 C₁-C₂₅-alkyl or C₂-C₂₅-alkenyl:
R19 C₁-C₄-alkyl or hydroxy-C₁-C₄-alkyl;
R20 C₁-C₄-alkyl, hydroxy-C₁-C₄-alkyl or a R₁—(CO)—R²¹—(CH₂)ⱼ— or —NH—; j: 2 or 3) radical,
   where at least one R18 radical is a C₇-C₂₂-alkyl.

In the context of the present invention, the surfactants (B_{L} or B_{F}) may also be amphoteric surfactants. Suitable amphoteric surfactants here are, e.g. alkyl betaines, alkylamide betaines, aminopropionates, aminoglycinates and amphoteric imidazolium compounds.

The content of surfactants in detergent and cleaning compositions of the invention in liquid and gel form is preferably 2 to 75 wt % and in particular 5 to 65 wt %, based in each case on the overall composition.

The content of surfactants in solid detergent and cleaning compositions of the invention is preferably 2 to 40 wt % and in particular 5 to 35 wt %, based in each case on the overall composition.

In the context of the present invention, suitable builders, cobuilders and complexing agents (C_{L} or C_{F}) include inorganic builders such as:
crystalline and amorphous aluminosilicates with ion-exchanging properties, such as in particular zeolites: Various types of zeolites are suitable, especially zeolites A, X, B, P, MAP and HS in the sodium form thereof, or in forms in which Na has been partially exchanged for other cations such as Li, K, Ca, Mg or ammonium.
crystalline silicates, such as in particular disilicates and sheet silicates, e.g. δ- and β-Na₂Si₂O₅. The silicates can be used in the form of their alkali metal, alkaline earth metal or ammonium salts, preference being given to the Na, Li and Mg silicates;
amorphous silicates, such as sodium metasilicate and amorphous disilicate;
carbonates and hydrogen carbonates: These can be used in the form of their alkali metal, alkaline earth metal or ammonium salts. Preference is given to Na, Li and Mg carbonates and hydrogen carbonates, in particular sodium carbonate and/or sodium hydrogen carbonate; and
polyphosphates, such as pentasodium triphosphate.

In the context of the present invention, suitable cobuilders and complexing agents (CL or CO include:
low molecular weight carboxylic acids such as citric acid, hydrophobically modified citric acid, e.g. agaric acid, malic acid, tartaric acid, gluconic acid, glutaric acid, succinic acid, imidodisuccinic acid, oxydisuccinic acid, propanetricarboxylic acid, butanetetracarboxylic acid, cyclopentanetetracarboxylic acid, alkyl- and alkenylsuccinic acids and aminopolycarboxylic acids, e.g. nitrilotriacetic acid, β-alaninediacetic acid, ethylenediaminetetraacetic acid, serinediacetic acid, isoserinediacetic acid, N-(2-hydroxyethyl)iminoacetic acid, ethylenediaminedisuccinic acid, glutamic acid diacetic acid and methyl- and ethylglycinediacetic acid or alkali metal salts thereof;
oligomeric and polymeric carboxylic acids, such as homopolymers of acrylic acid, copolymers of acrylic acid with sulfonic acid group-containing comonomers such as 2-acrylamido-2-methylpropanesulfonic acid (AMPS), allylsulfonic acid and vinylsulfonic acid, oligomaleic acids, copolymers of maleic acid with acrylic acid, methacrylic acid or C₂-C₂₂-olefins, e.g. isobutene or long chain α-olefins, vinyl-C₁-C₈-alkyl ethers, vinyl acetate, vinyl propionate, (meth)acrylic esters of C₁-C₈-alcohols and styrene. Preference is given to the homopolymers of acrylic acid and copolymers of acrylic acid with maleic acid or AMPS. The oligomeric and polymeric carboxylic acids are used in acid form or as the sodium salt;
phosphonic acids such as 1-hydroxyethylene(1,1-diphosphonic acid), aminotri(methylenephosphonic acid), ethylenediaminetetra(methylenephosphonic acid) and diethylenetriaminepenta(methylenephosphonic acid) and alkali metal salts thereof.

Suitable bleaches (D_{L} or D_{F}) in accordance with the invention include: sodium perborate tetrahydrate, sodium perborate monohydrate, sodium percarbonate, peroxypyrophosphates, citrate perhydrates and also peracid salts or peracids such as perbenzoates, peroxophthalates, diperazelaic acid, phthaloimino peracid or diperdodecanedioic acid. In order to wash at temperatures of 60° C. and to achieve an improved bleach effect, bleach activators may, in accordance with the invention, be incorporated into the detergents or cleaning compositions. Bleach activators used can be, for example, compounds which, under perhydrolysis conditions, give rise to aliphatic peroxocarboxylic acids having preferably 1 to 10 carbon atoms, in particular 2 to 4 carbon atoms, and/or optionally substituted perbenzoic acid. Suitable are substances, inter alia, which bear O-acyl and/or N-acyl groups of the carbon atom number specified and/or optionally substituted benzoyl groups. In accordance with the invention, polyacylated alkylenediamines are preferred, in particular tetraacetylethylenediamine (TAED), acylated triazine derivatives, particularly 1,5-diacetyl-2,4-dioxohexahydro-1,3,5-triazine (DADHT), acylated glycolurils, in particular tetraacetylglycoluril (TAGU)1 N-acylimides, particularly N-nonanoylsuccinimide (NOSI), acylated phenolsulfonates, particularly n-nonanoyl- or isononanoyloxybenzenesulfonate (n- or iso-NOBS), carboxylic anhydrides, particularly phthalic anhydride, acylated polyhydric alcohols, in particular triacetin, ethylene glycol diacetate and 2,5-diacetoxy-2,5-dihydrofuran. In addition to the conventional bleach activators or in their stead, what are called bleach catalysts may also be incorporated in accordance with the invention into the liquid detergent or cleaning composition as constituents (D_{L}). These substances are bleach-enhancing transition metal salts or transition metal complexes such as salen complexes or carbonyl complexes of Mn, Fe, Co, Ru or Mo. Also usable as bleach catalysts are complexes of Mn, Fe, Co, Ru, Mo, Ti, V and Cu with nitrogen-containing tripod ligands and also amine complexes of Co, Fe, Cu and Ru.

Customary ingredients for cleaning or detergent compositions (E_{L} or E_{F}) are known to those skilled in the art and comprise, for example, alkali carriers, defoamers, enzymes (e.g. lipases, proteases, amylases, cellulases), dyes, fragrances, perfume carriers, graying inhibitors, dye transfer inhibitors, color protection additives, fiber protection additives, optical brighteners, soil release polyesters, corrosion inhibitors, bactericides and preservatives, organic solvents, solubilizers, pH modifiers, hydrotropes, thickeners, rheology modifiers and/or alkanolamines for liquid or gel-type cleaning or detergent compositions (E_{L}), or modifiers (e.g. sodium sulfate), defoamers, enzymes (e.g. lipases, proteases, amylases, cellulases), dyes, fragrances, perfume carriers, graying inhibitors, dye transfer inhibitors, color protection additives, fiber protection additives, optical brighteners, soil release polyesters, corrosion inhibitors, bactericides and preservatives, dissolution promoters, disintegrants, process auxiliaries and/or water for solid cleaning or detergent compositions (E_{F}).

Suitable enzymes (E_{L} or E_{F}) in accordance with the invention are in particular those from the classes of the hydrolases, such as the proteases, esterases, lipases or lipolytic enzymes, amylases, cellulases and other glycosyl hydrolases and mixtures of said enzymes. All of these hydrolases contribute during washing to the removal of stains such as protein-, fat- or starch-containing stains and graying. Cellulases and other glycosyl hydrolases can moreover contribute to the color retention and to increasing the softness of the textile by removing pilling and microfibrils. Oxyreductases can also be used for the bleaching or for the inhibition of color transfer. Of particularly good suitability are active enzymatic ingredients obtained from bacterial strains or fungi such as Bacillus subtilis, Bacillus khenitormis, Streptomyceus griseus and Humicola insolens. Preference is given to using proteases of the subtilisin type and in particular proteases which are obtained from Bacillus lentus. Here, enzyme mixtures, for example of protease and amylase or protease and lipase or lipolytic enzymes or protease and cellulase or of cellulase and lipase or lipolytic enzymes or of protease, amylase and lipase or lipolytic enzymes or protease, lipase or lipolytic enzymes and cellulase, but in particular protease and/or lipase-containing mixtures or mixtures with lipolytic enzymes are of particular interest. Examples of such lipolytic enzymes are known cutinases. Peroxidases or oxidases may also be used in this case. The suitable amylases include especially α-amylases, isoamylases, pullulanases and pectinases. Cellulases used are preferably cellobiohydrolases, endoglucanases and β-glucosidases, which are also called cellobiases, or mixtures of these. Since different cellulase types differ by their CMCase and avicelase activities, it is possible to establish the desired activities by means of selected mixtures of the cellulases.

The enzymes may, in accordance with the invention, be adsorbed on carrier substances in order to protect them from premature breakdown. The proportion of the enzymes, enzyme mixtures or enzyme granules may be, in accordance with the invention, for example, about 0.1 to 5 wt %, preferably 0.12 to about 2.5 wt %, based in each case on the total formulation.

Suitable graying inhibitors (E_{L} or E_{F}) are, for example, carboxymethylcellulose, graft polymers of vinyl acetate on polyethylene glycol, and alkoxylates of polyethyleneimine.

As thickeners (E_{L}), so-called associative thickeners may be used. Suitable examples of thickeners are known to those skilled in the art and are described, inter alia, in WO 2009/019225 A2, EP 013 836 or WO 2006/016035.

In the context of the present invention, optical brighteners (called “whiteners”) (E_{L} or E_{F}) can be added to the liquid detergents or cleaning compositions in order to eliminate graying and yellowing of the treated textile fabrics. These substances attach to the fibers and bring about a brightening and simulated bleaching effect by converting invisible ultraviolet radiation to visible longer-wave light, with emission of the ultraviolet light absorbed from the sunlight as pale bluish fluorescence to give pure white with the yellow shade of grayed and/or yellowed laundry. Suitable compounds originate, for example, from the substance classes of the 4,4′-diamino-2,2°-stilbenedisulfonic acids (flavonic acids), 4,4′-distyrylbiphenylene, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles. The optical brighteners are typically used in amounts between 0.03 and 0.3 wt %, based on the finished composition.

Suitable dye transfer inhibitors (E_{L} or E_{F}) are, in accordance with the invention, for example, homopolymers, copolymers and graft polymers of 1-vinylpyrrolidone, 1-vinylimidazole or 4-vinylpyridine N-oxide. Homopolymers and copolymers of 4-vinylpyridine reacted with chloroacetic acid are also suitable as dye transfer inhibitors.

Detergent ingredients are otherwise generally known. Detailed descriptions can be found, for example, in WO 99/06524 and WO 99/04313; in Liquid Detergents, Editor: Kuo-Yann Lai, Surfactant Sci. Ser., Vol. 67, Marcel Decker, New York, 1997, pp. 272-304. Further detailed descriptions of the detergent and cleaning composition ingredients can be found, for example, in: Handbook of Detergents, Part D: Formulation, Surfactant Sci Ser, Vol. 128, Editor: Michael S. Showell, CRC Press 2006; Liquid Detergents sec. edition, Surfactant Sci Ser, Vol, 129, Editor: Kuo-Yann Lai, CRC Press 2006; or Waschmittel: Chemie, Umwelt, Nachhaltigkeit [Detergents: Chemistry, Environment, Sustainability], Günter Wagner, Wiley-VCH Verlag GmbH & Co. KGaA, August 2010.

The present invention further relates to the use of modified polyaspartic acids preparable in accordance with the invention as washing power enhancers, graying inhibitors and encrustation inhibitors in detergent compositions and cleaning compositions (e.g. as additives for detergents and cleaning compositions for textiles, washing aids, laundry aftertreatment agents).

The invention further relates to the use of polyaspartic acids of the invention or mixtures thereof as scale inhibitors or dispersants in water-conducting systems. Water-conducting systems in which polyaspartic acids preparable by the process of the invention can be used are in principle all systems which come into contact permanently or periodically with water such as seawater, brackish water, river water, urban or industrial wastewater or industrial process water such as cooling water, and in which scale formation can occur.

Water-conducting systems in which the polymers of the invention can be used are, in particular, seawater desalination plants, brackish water desalination plants, cooling water systems and boiler feed water systems, boilers, heaters, continuous-flow heaters, hot water tanks, cooling towers, cooling water circuits and other industrial process waters. The desalination plants may be thermal in nature or based on membrane processes such as reverse osmosis or electrodialysis.

In general, the polymers of the invention are added to the water-conducting systems in amounts of 0.1 mg/l to 100 mg/l. The optimal dosage is determined by the requirements of the respective application or according to the operating conditions of the relevant process. For instance, in thermal seawater desalination, the polymers are preferably used at concentrations of 0.5 mg/l to 10 mg/l. Polymer concentrations of up to 100 mg/l are used in industrial cooling circuits or boiler feed water systems. Water analyses are often carried out in order to determine the fraction of scale-forming salts and thus the optimal dosage.

Formulations may also be added to the water-conducting systems which may comprise, in addition to the polymers of the invention and depending on requirements, inter alia, phosphonates, polyphosphates, zinc salts, molybdate salts, organic corrosion inhibitors such as benzotriazole, tolyltriazole, benzimidazole or ethynyl carbinol alkoxylates, biocides, complexing agents and/or surfactants. Examples of phosphonates are 1-hydroxyethane-1,1-diphosphonic acid (HEDP), 2-phosphonobutane-1,2,4-tricarboxylic acid (PBTC), aminotrimethylenephosphonic acid (ATMP) diethylenetriaminepenta(methylenephosphonic acid) (DTPMP) and ethylenediaminetetra(methylenephosphonic acid) (EDTMP), which are used in each case in acid form or in the form of sodium salts thereof.

The following examples serve to illustrate the present invention and must not to be understood as a restriction.

### EXAMPLE 1

### Preparation of the Modified Polyaspartic Acids

Reported ratios are molar ratios.

### Inventive Polymers

Polymer 1: Polycondensate of L-aspartic acid/BTC/HMDA 1.0/0.2/0.2
Polymer 2: Polycondensate of L-aspartic acid/citric acid/HMDA 1.0/0.05/0.025
Polymer 3: Polycondensate of L-aspartic acid/citric acid/ethylenediamine 1.0/0.2/0.075
Polymer 4: Polycondensate of L-aspartic acid/BTC/4,7,10-trioxatridecane-1,13-diamine 1.0/0.2/0.2
Polymer 5: Polycondensate of L-aspartic acid/BTC/polyetheramine of the formula I with n=2.5 1.0/0.2/0.2
Polymer 6: Polycondensate of L-aspartic acid/BTC/polyetheramine of the formula I with n=3.5 1.0/0.1/0.1
Polymer 7: Polycondensate of L-aspartic acid/BTC/ethanolamine 1/0.2/0.15

### Comparative Polymers

Polymer C1: Polyaspartic acid, sodium salt, Mw 3000 g/mol
Polymer C2: Polyaspartic acid, sodium salt, Mw 5400 g/mol
Polymer C3: Polycondensate of L-aspartic acid/BTC 1.0/0.2, Mw 1870 g/mol
Polymer C4: Copolymer of MA/NH₃/citric acid monohydrate/HMDA 1.0/1.1/0.05/0.014 (according to example 5 from WO 95/021882)
BTC=butane-1,2,3,4-tetracarboxylic acid
HMDA=hexamethylenediamine
MA=maleic anhydride

### Inventive Polymers

### Polymer 1:

The reactor was initially charged with 133.10 g of L-aspartic acid, 46.83 g of butane-1,2,3,4-tetracarboxylic acid and 23.24 g of hexamethylenediamine, which were polycondensed at 220° C. for 7 h. The resulting melt of the modified polyaspartimide was cooled down, comminuted and hydrolyzed to give an aqueous sodium salt solution of the modified polyaspartic acid. In order to prepare the aqueous sodium salt solution of the modified polyaspartic acid, 100 g of the comminuted reaction mixture were dispersed in 100 g of water, the mixture was heated to 70° C. and sufficient 50% aqueous sodium hydroxide solution was added at this temperature that the pH was in the range of 7-8. The water-dispersed powder dissolved gradually to give a clear aqueous sodium salt solution of the modified polyaspartic acid. The weight-average molecular weight Mw of the modified polyaspartic acid was 4300 g/mol.

### Polymer 2:

Analogously to polymer 1, the reactor was initially charged with 133.10 g of L-aspartic acid, 30.00 g of water, 9.61 g of citric acid and 2.91 g of hexamethylenediamine, which were polycondensed at 220° C. for 5 h. The resulting melt of the modified polyaspartimide was cooled down, comminuted and, analogously to polymer 1, hydrolyzed to give an aqueous sodium salt solution of the modified polyaspartic acid. The weight-average molecular weight Mw of the modified polyaspartic acid was 8760 g/mol.

### Polymer 3:

Analogously to polymer 1, the reactor was initially charged with 133.10 g of L-aspartic acid, 30.00 g of water, 38.43 g of citric acid and 4.50 g of ethylenediamine, which were polycondensed at 220° C. for 7 h. The resulting melt of the modified polyaspartimide was cooled down, comminuted and, analogously to polymer 1, hydrolyzed to give an aqueous sodium salt solution of the modified polyaspartic acid. The weight-average molecular weight Mw of the modified polyaspartic acid was 9470 g/mol.

### Polymer 4:

Analogously to polymer 1, the reactor was initially charged with 133.10 g of L-aspartic acid, 30.00 g of water, 46.83 g of butane-1,2,3,4-tetracarboxylic acid and 44.06 g of 3-[2-[2-(3-aminopropoxy)ethoxy]ethoxy]propan-1-amine, which were polycondensed at 220° C. for 7 h. The resulting melt of the modified polyaspartimide was cooled down, comminuted and, analogously to the description for polymer 1, hydrolyzed to give an aqueous sodium salt solution of the modified polyaspartic acid. The weight-average molecular weight Mw of the modified polyaspartic acid was 22000 g/mol.

### Polymer 5:

Analogously to polymer 1, the reactor was initially charged with 133.10 g of L-aspartic acid, 30.00 g of water, 46.83 g of butane-1,2,3,4-tetracarboxylic acid and 46.00 g of the formula I with n=2.5, which were polycondensed at 220° C. for 7 h. The resulting melt of the modified polyaspartimide was cooled down, comminuted and, analogously to polymer 1, hydrolyzed to give an aqueous sodium salt solution of the modified polyaspartic acid. The weight-average molecular weight Mw of the modified polyaspartic acid was 11400 g/mol.

### Polymer 6:

Analogously to polymer 1, the reactor was initially charged with 133.10 g of L-aspartic acid, 30.00 g of water, 23.42 g of butane-1,2,3,4-tetracarboxylic acid and 23.00 g of polyetheramine of the formula I with n=2.5, which were polycondensed at 220° C. for 7 h. The resulting melt of the modified polyaspartimide was cooled down, comminuted and, analogously to polymer 1, hydrolyzed to give an aqueous sodium salt solution of the modified polyaspartic acid. The weight-average molecular weight Mw of the modified polyaspartic acid was 13150 g/mol.

### Polymer 7:

Analogously to polymer 1, the reactor was initially charged with 133.10 g of L-aspartic acid, 30.00 g of water, 46.83 g of butane-1,2,3,4-tetracarboxylic acid and 9.17 g of ethanolamine, which were polycondensed at 220° C. for 7 h. The resulting melt of the modified polyaspartimide was cooled down, comminuted and, analogously to polymer 1, hydrolyzed to give an aqueous sodium salt solution of the modified polyaspartic acid. The weight-average molecular weight Mw of the modified polyaspartic acid was 3800 g/mol.

### Comparative Polymers

### Polymer C1:

In a round-bottomed flask, 10 g of maleamide (prepared by the reaction of maleic anhydride with ammonia) were polycondensed at 240° C. for 2 h. The reaction mixture expanded like a foam and was easily comminuted after cooling. The comminuted polyaspartimide was hydrolyzed analogously to polymer 1 to give an aqueous polyaspartic acid sodium salt solution. The weight-average molecular weight Mw was 3000 g/mol.

### Polymer C2:

133.10 g of L-aspartic acid were polycondensed at a temperature of 220-240° C. for 2 h in a rotary evaporator. The resulting polyaspartimide was hydrolyzed analogously to the description for polymer 1 to give an aqueous polyaspartic acid sodium salt solution. The weight-average molecular weight Mw was 5400 g/mol.

### Polymer C3:

A 2 L reactor with stirrer was initially charged with 133.10 g of L-aspartic acid, 70 g of water and 46.83 g of butane-1,2,3,4-tetracarboxylic acid. The reaction mixture was heated while stirring at a temperature of 240° C. for 2.5 h with simultaneous distillative removal of water. The resultant melt of the modified polyaspartimide is cooled down and then comminuted. In order to prepare the aqueous sodium salt solution of the modified polyaspartic acid, 100 g of the comminuted reaction mixture are dispersed in 100 g of water, the mixture is heated to 70° C. and sufficient 50% aqueous sodium hydroxide solution is added at this temperature that the pH is in the range of 7-8. The water-dispersed powder dissolves gradually to give a clear aqueous sodium salt solution of the modified polyaspartic acid. The weight-average molecular weight (Mw) of the modified polyaspartic acid is 1870 g/mol.

### Polymer C4:

A polyaspartic acid/citric acid copolymer was prepared according to the description of example 5 from WO 95/021882. Initially charged were 2.1 g (0.01 mol) of citric acid monohydrate together with 0.32 g of HMDA (0.0028 mol) to give 19.6 g (0.2 mol) of maleic anhydride as described in WO 95/021882 and 30 g of 30% aqueous NH₃ solution (0.22 mol). The polymerization was conducted as described in example 5 of WO 95/021882. A relatively low-viscosity solution was obtained. The weight-average molecular weight (Mw) of the copolymer formed was measured as described in example 2 herein. It was 750 g/mol. Subsequently, a CaCO₃ inhibition test was conducted as described in example 3 herein, and the results were listed in table 1.

### EXAMPLE 2

### Determination of Molecular Weight (Mw)

The weight-average molecular weight (Mw) of the examples was determined by GPC (gel permeation chromatography) under the following conditions:

| | |
|---|---|
| Column | Suprema 100 10μ (from Polymer Standard Service) |
| Eluent | 0.08 mol/L TRIS buffer pH 7.0 in dist. water + 0.15 |
| | mol/L NaCl + 0.01 mol/L NaN₃. |
| Column temperature | 35° C. |
| Flow rate | 0.8 ml/min |
| Injection | 100 μL |
| Concentration | 1.5 mg/mL |
| Detector | DRI Agilent 1100UV GAT-LCD 503 (260 nm) |

Sample solutions were filtered through Sartorius Minisart RC 25 (0.2 μm). Calibration was effected with narrow-distribution Na-PAA standards from Polymer Standard Service with molecular weights of M=1250 to M=193 800. In addition, sodium acrylate having a molecular weight of M=96 and a PEG standard with M=620 which with Na-PAA M=150 was equated. Values outside this elution range were extrapolated. The evaluation limit was 295 g/mol.

### EXAMPLE 3

### Calcium Carbonate Inhibition Test

A solution of NaHCO₃, MgSO₄, CaCl₂ and polymer was shaken at 70° C. for 2 h in a water bath. After filtration of the still-warm solution through a 0.45 μm Milex filter, the calcium content of the filtrate was determined by complexometry or by means of a Ca²⁺-selective electrode and determined in % by comparison before/after the CaCO₃ inhibition (see formula X).

| | | |
|---|---|---|
| Ca²⁺ | 215 | mg/L |
| Mg²⁺ | 43 | mg/L |
| HCO₃⁻ | 1220 | mg/L |
| Na⁺ | 460 | mg/L |
| Cl⁻ | 380 | mg/L |
| SO₄²⁻ | 170 | mg/L |
| Polymer | 3 | mg/L |
| Temperature | 70° | C. |
| Time | 2 | hours |

| | |
|---|---|
| pH | 8.0-8.5 |

CaCO₃ inhibition (%)=[(mg (Ca²⁺) after 24 h−mg (Ca²⁺) blank value after 24 h)/(mg (Ca²⁺) zero value−mg (Ca²⁺) blank value after 24 h)]×100 Formula X:

TABLE 1
CaCO₃ inhibition

| Example | Inhibition [%] |
|---|---|
| 1 | 64.0 |
| 2 | 71.0 |
| 3 | 58.9 |
| 7 | 65.9 |
| Polymer C1 | 47.8 |
| Polymer C3 | 52.3 |
| Polymer C4 | 13.9 |

### EXAMPLE 4

### Dishwashing Machine Test

The polymers were tested in the following phosphate-free formulation PF1.

TABLE 2
Dishwashing composition test formulation 1 (PF1)

| Constituent | PF 1 |
|---|---|
| Protease | 2.5 |
| Amylase | 1.0 |
| Nonionic surfactant | 5 |
| Polymer | 10 |
| Sodium percarbonate | 10.2 |
| Tetraacetylethylenediamine | 4 |
| Sodium disilicate | 2 |
| Sodium carbonate | 19.5 |
| Sodium citrate dihydrate | 35 |
| Methylglycinediacetic acid, | 10 |
| Na salt | |
| Hydroxyethane-(1,1- | 0.8 |
| diphosphonic acid) | |

Values in wt % based on the total amount of all components

The following experimental conditions were observed:
Dishwasher: Miele G 1222 SCL
Program: 65° C. (with pre-rinse)
Dishes washed: 3 knives (Karina nickel chrome knives, Solex Germany GmbH, D-75239 Eisingen)
   3 Amsterdam 0.2 L drinking glasses
   3 “OCEAN BLUE” BREAKFAST DISHES (MELAMINE)
   3 porcelain dishes: 19 CM FLAT RIMMED PLATES
Arrangement: Knives in the cutlery rack, glasses in the upper basket, plates in the lower basket
Dishwashing composition: 18 g
Soil addition: 50 g of ballast soil in thawed form is dosed in with the formulation after the pre-rinse; for composition see below
Wash temperature: 65° C.
Water hardness: 21° GH (Ca/Mg):HCO3 (3:1):1.35
Wash cycles: 15; 1 h pause between each cycle (door closed for 10 min, door open for 50 min)
Evaluation: Visually after 15 cycles

The dishes washed were evaluated after 15 cycles in a darkened chamber with light behind an aperture plate using a grading scale from 10 (very good) to 1 (very poor). Marks of 1-10 were awarded for spotting (very many intense spots=1 to no spots=10) and for scaling (1=very intense scaling, 10=no scaling)

### Composition of the Ballast Soil:

Starch: 0.5% potato starch, 2.5% gravy
Fat: 10.2% margarine
Protein: 5.1% egg yolk, 5.1% milk
Others: 2.5% tomato ketchup, 2.5% mustard, 0.1% benzoic acid, 71.5% water

### Result

The formulations with polyaspartic acid modified in accordance with the invention were notable particularly for their very high scale-inhibiting effect with respect to inorganic and organic deposits on glass and knives. Furthermore, they increased the cleaning power of the dishwashing composition and promoted the draining of water from the dishes washed, such that particularly clear glasses and shiny metal cutlery items were obtained.

The table below lists the cumulative marks for scale formation (B) and spotting (S) on knives and drinking glasses.

TABLE 3
Test result for dishwashing composition test formulation 1 (PF1)

| Polymer | Knives (B + S) | Glasses (B + S) |
|---|---|---|
| No polymer | 7.0 | 7.0 |
| Polymer 1 | 13.7 | 10.3 |
| Polymer 2 | 14.0 | 15.0 |
| Polymer 3 | 16.3 | 14.0 |
| Polymer 4 | 16.0 | 12.7 |
| Polymer 5 | 16.0 | 13.7 |
| Polymer 6 | 17.0 | 12.3 |
| Polymer 7 | 15.7 | 11.7 |
| Polymer C1 | 8.3 | 7.7 |
| Polymer C2 | 12.3 | 9.0 |

### EXAMPLE 5

### Determination of Inorganic Fabric Deposition (Encrustation)

The detergent formulation described in table 4 was used to wash cotton test fabrics. The wash conditions are shown in table 5. The number of wash cycles was 15. After this number of washes, the ash content of the test fabric was ascertained by ashing at 700° C.

TABLE 4
Detergent test formulation 2 (PF2)

| Constituent | PF 2 |
|---|---|
| Linear C₉-C₁₃- | 15 |
| alkylbenzenesulfonate (LAS) | |
| C12-C14 fatty alcohol x 7 EO | 3 |
| Polymer | 5 |
| Sodium silicate | 10 |
| Sodium carbonate | 20 |
| Sodium citrate dihydrate | 2 |
| Soap | 1.5 |
| Carboxymethyl cellulose | 1.0 |
| Diethylentriaminepenta(methylene- | 0.5 |
| phosphonic acid) | |
| Sodium sulfate | 42 |

Values in wt % based on the total amount of all components

TABLE 5
Encrustation wash conditions

| Appliance | Launder-o-meter from Atlas, Chicago, USA | |
|---|---|---|
| Wash liquor | 250 | ml |
| Wash duration | 20 | min |
| Wash temperature | 60° | C. |
| Wash cycles | 15 | |
| Washing composition | 5 | g/L |
| dosage | | |

| | |
|---|---|
| Water hardness | 3.2 mmol/L Ca, 0.8 mmol/L Mg, |
| | 6.4 mol/L hydrogencarbonate |
| Liquor ratio | 1:12.5 |
| Test fabric | wfk 10A cotton test fabric |

wfk = wfk cleaning technology institute e.V., Krefeld, Germany

Table 6 below lists the test results (ash content of the fabric in wt %).

TABLE 6
Test results for detergent test formulation 2 (PF2)

| Polymer | Ash content in wt % |
|---|---|
| No polymer | 3.85 |
| Polymer 1 | 1.70 |
| Polymer 2 | 1.65 |
| Polymer 5 | 1.55 |
| Polymer 7 | 1.50 |
| Polymer C2 | 2.15 |
| Polymer C3 | 2.30 |

1.-11. (canceled)

12. A process for preparing modified polyaspartic acid or salts thereof, comprising the following steps:
(i) polycondensation of
(a) 50 to 98 mol % of aspartic acid,
(b) 1 to 49 mol % of at least one compound containing carboxyl groups, and
(c) 1 to 30 mol % of a diamine or an amino alcohol,
at a temperature of 100 to 270° C. for 1 minute to 50 hours, where (b) is not aspartic acid;
(ii) subsequent hydrolysis of the cocondensates with addition of a base; and
(iii) optional acidification of the salt of polyaspartic acid obtained in (ii) with mineral acids.

13. The process according to claim 12, wherein the ratio of (b):(c) is between 5:1 and 1:1.5.

14. The process according to claim 12, wherein the ratio of (b):(c) is between 2:1 and 1:1.2.

15. The process according to claim 14, wherein the polycondensation is of
(a) 60 to 90 mol % of aspartic acid,
(b) 3 to 40 mol % of at least one compound containing carboxyl groups, and
(c) 1 to 25 mol % of a diamine or an amino alcohol.

16. The process according to claim 12, wherein the polycondensation is of
(a) 70 to 95 mol % of aspartic acid,
(b) 5 to 30 mol % of at least one compound containing carboxyl groups, and
(c) 2 to 20 mol % of a diamine or an amino alcohol.

17. A modified polyaspartic acid or salts thereof obtained by the process according to claim 12.

18. A dishwashing composition comprising
(A_{S}) 1-20 wt % of at least one modified polyaspartic acid according to claim 14;
(B_{S}) 0-50 wt % of complexing agents;
(C_{S}) 0.1-80 wt % of builders and/or cobuilders;
(D_{S}) 0.1-20 wt % of nonionic surfactants;
(E_{S}) 0-30 wt % of bleaches, bleach activators and bleach catalysts;
(F_{S}) 0-8 wt % of enzymes; and
(G_{S}) 0-50 wt % of additives.

19. The dishwashing composition as claimed in claim 18, wherein component (As) is 1-15 wt % of at least one modified polyaspartic acid

20. The dishwashing composition as claimed in claim 18, wherein component (As) is 2-12 wt % of at least one modified polyaspartic acid

21. A detergent and cleaning composition in liquid or gel form, comprising
(A_{L}) 0.1 to 20 wt % of at least one modified polyaspartic acid according to claims 14,
(B_{L}) 1 to 80 wt % of surfactants,
(C_{L}) 0.1 to 50 wt % of builders, cobuilders and/or complexing agents,
(D_{L}) 0 to 20 wt % of bleach system,
(E_{L}) 0.1 to 60 wt % of detergent or cleaning composition ingredients, and
(F_{L}) 0 to 98.7 wt % of water.

22. A solid detergent and cleaning composition comprising
(A_{F}) 0.1 to 20 wt % of at least one modified polyaspartic acid according to claim 14,
(B_{F}) 1 to 50 wt % of surfactants,
(C_{F}) 0.1 to 70 wt % of builders, cobuilders and/or complexing agents,
(D_{F}) 0 to 30 wt % of bleach system, and
(E_{F}) 0.1 to 70 wt % of detergent or cleaning composition ingredients.

23. A scale inhibitor and/or dispersant comprising the modified polyaspartic acid obtained according to process 12.

24. An additive in cleaning, dishwashing or detergent compositions which comprises the modified polyaspartic acid obtained according to process 12.

25. A scale inhibitor and/or dispersant in water-conducting systems which comprises the modified polyaspartic acid obtained according to process 12.

26. The scale inhibitor according to claim 24, wherein the water-conducting system is selected from the group consisting of seawater desalination plant, brackish water desalination plant, cooling water system, boiler feed water system and industrial process water.

27. The scale inhibitor according to claim 26, wherein 0.1 mg/L to 100 mg/L of modified polyaspartic acid is used.
